(19) United States
(12) Patent Application Publication
(10) Pub. No.: US 2009/0288595 A1
(43) Pub. Date: Nov. 26, 2009

(54) DEVICE WITH REVOLVING SHAFTS FOR TRANSVERSELY SOAKING PREPREG

(76) Inventor: Yufang HE, Dongguan (CN)

Correspondence Address: Dr. BANGER SHIA;Int''l Patent Office of Bang Shia, 102 Lindencrest Ct, Sugar Land, TX, 77479-5201, US

(21) Appl. No.: 12/126,863

(22) Filed: May 24, 2008

(51) Int. Cl. B05C 3/00; B05C 19/02

(52) U.S. Cl. 118/423

(57) ABSTRACT

The present invention pertains to a device with revolving shafts for transversely soaking prepreg which comprises a basin filled with resin glue and revolving shafts disposed therein for laterally transporting a prepreg from the bottom side of the basin to the top side thereof. By means of the transverse route of the prepreg conducted by the revolving shafts, the time of soaking the prepreg in the basin is extended so as to reduce bubbles existed in the prepreg via fully immersing the resin glue throughout the prepreg and further increase the composite quality of the copper-clad laminate and the reliability of the metal resistant ion. Therefore, the present invention facilely gets acclimated to the industry without adding more equipment.

### BACKGROUND OF THE INVENTION

1. Field of the Invention

The present invention relates to a device for producing prepreg applied to a copper-clad laminate, particularly to a device with revolving shafts for transversely soaking prepreg.

2. Description of the Related Art

Typically, a copper clad sheet is the essential material of PCB and composed of epoxy resin, fiber glass cloth (one material of the prepreg), and copper tinsel. The quality of copper-clad laminate directly relates to the function of PCB, and the prepreg plays an important role in the copper-clad laminate, namely the wetness between the prepreg and the epoxy resin greatly influences the quality of the copper-clad laminate.

Referring to FIG. 1, the conventional device for soaking prepreg, for instance of Japanese Patent JP2000061939, mainly comprises a basin 1 filled with epoxy resin, a plurality of revolving shafts 2 disposed therein, and a prepreg 3 longitudinally winded on the shafts 2; wherein, the prepreg 3 is supplied from the top side of the basin 1 and longitudinally transported to the bottom side of the basin 1, and then in turn from the bottom side toward the top side, whereby the prepreg 3 keeps soaked within the basinful epoxy resin of the basin 1. Further, the prepreg 3 is conveyed to a glue stove 5 through a pair of pressing shafts 4 for a drying procedure. However, due to the longitudinally route of the prepreg 3, the soaking time of the prepreg 3 in the epoxy resin is so short that the prepreg 3 cannot be fully immersed by the resin. Further, the finishing prepreg 3 still has bubbles to be existed therein and finally affects the quality of the copper-clad laminate. Therefore, some other relative devices are produced to improve the above deficiencies. As shown in Chinese Patent CN1734003A and CN1872760A, both of them increase other equipment for solving the above problem but also require complicate operations, so the conventional devices still need improvements.

### SUMMARY OF THE INVENTION

The object of the present invention is to provide a device with revolving shafts for transversely soaking prepreg which improves the problem of insufficiently immersion of the prepreg by extending the soaking time of the prepreg in the basin.

The device with revolving shafts for transversely soaking prepreg in accordance with the present invention essentially comprises a basin with resin glue, a plurality of revolving shafts inside the basin, and a prepreg winding on the shafts. By means of the revolving shafts transversely guiding the prepreg to be conveyed from the bottom side of the basin to the top side thereof and thence to a pressing shaft and a glue stove, the soaking time of the prepreg is extended for immersing the resin glue throughout the prepreg and reducing bubbles existed in the prepreg. Thus, the present invention assists in increasing the composite quality of the copper-clad laminate and the reliability of the metal resistant ion without the increment of other equipment.

The advantages of the present invention over the known prior arts will become more apparent to those of ordinary skilled in the art by reading the following descriptions with the relating drawing.

### BRIEF DESCRIPTION OF THE DRAWINGS

FIG. 1 is a schematic view showing a conventional device;

FIG. 2 is a schematic view showing a preferred embodiment of the present invention;

FIG. 3a is a schematic view showing the conventional prepreg of FIG. 1 under the observation of the microscope;

FIG. 3b is a schematic view showing the present prepreg of FIG. 2 under the observation of the microscope; and

FIG. 4 is a schematic view showing another preferred embodiment of the present invention.

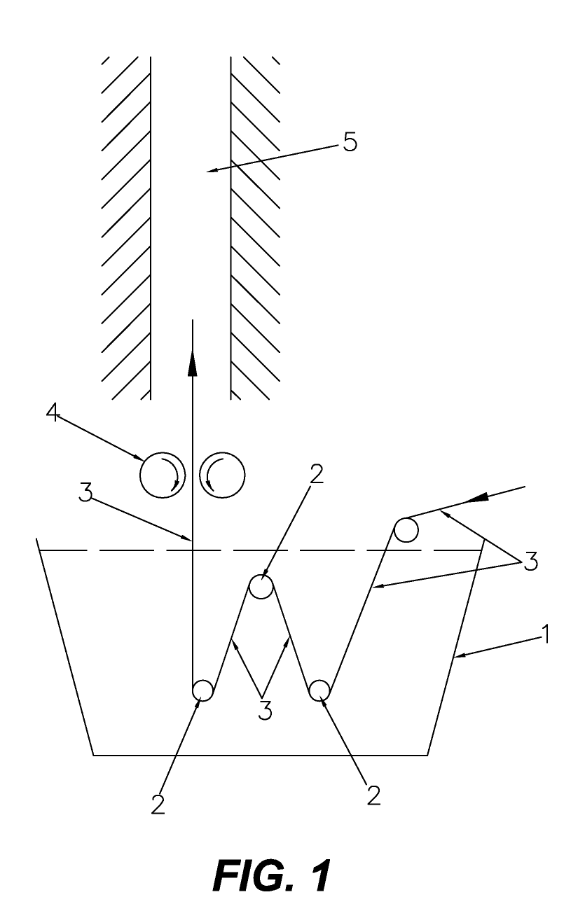

### DETAILED DESCRIPTION OF THE PREFERRED EMBODIMENTS

Before the present invention is described in greater detail, it should be noted that the like elements are denoted by the same reference numerals throughout the disclosure.

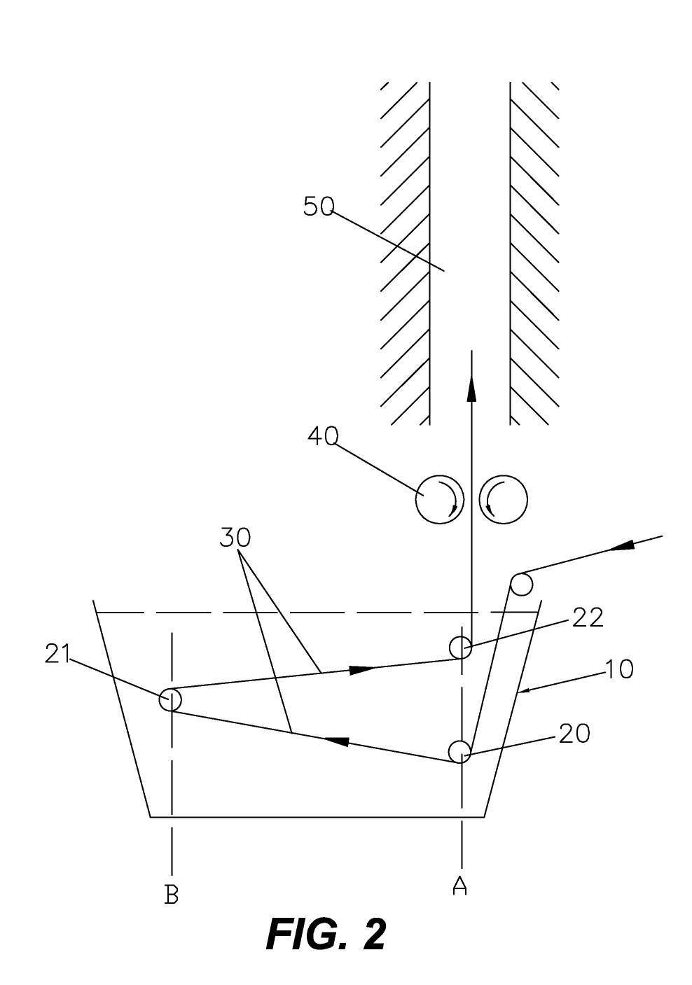

Referring to FIG. 2, a device for transversely soaking prepreg of one preferred embodiment of the present invention comprises a basin 10 filled with resin glue; wherein, three revolving shafts 20,21,22, are respectively disposed inside the basin 10 for allowing a prepreg 30 to sequentially wind on the first revolving shaft 20, round the second revolving shaft 21, and then to the third revolving shaft 22 (as arrowed in FIG. 2). The prepreg 30 herein can be fabricated of a fiber glass cloth, a fiber sheet or a fiber fabric. Further, the first revolving shaft 21 longitudinally aligns with the third revolving shaft 23 to form an imagine line A, and the second revolving shaft 22 is located with respect to an imagine line B. Both imagine lines A and B are in parallel and perpendicular to the bottom of the basin 10. Therefore, the prepreg 30 is able to laterally surround on the three shafts 21, 22, 23 from the bottom side of the basin 10 toward the top side thereof, subsequently pass through a pressing shaft 40 for extruding the superfluous resin glue immersed in the prepreg 30, and go into a glue stove 5 for a drying process.

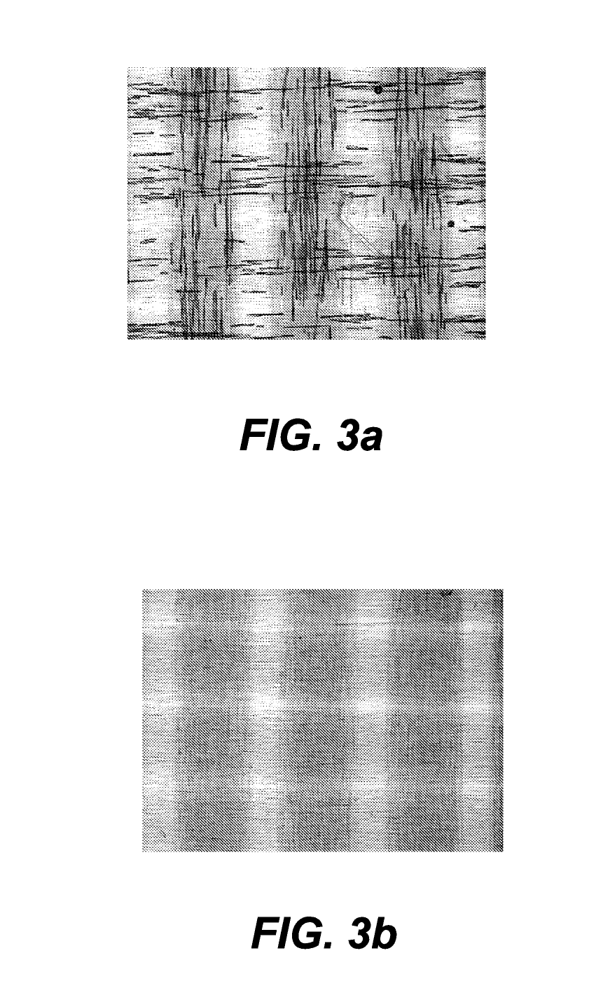

Base on the experimental tests, the device with revolving shafts for transversely soaking prepreg of the present invention produces the finishing prepreg 30 preferable to the conventional prepreg 3 under the correspondent conditions. For instance, the width of the basin bottom is 60 cm, the width of the basin top is 120 cm, the height of the basin is 70 cm, the height of the resin glue is 60 cm, the diameter of the revolving shaft is 10 cm, the numerals of the revolving shaft are three, the prepreg model number is 7628, the device speed is 12 m/min, and the viscosity of the resin glue is 22 s (via 3# cup test). Referring to the experimental result in FIG. 3a, the conventional prepreg 3 appreciably has lots of bubbles existed therein, and which indicates that the resin glue is not fully immersed into the prepreg 3. In contract, the prepreg 30 produced by the present invention does not have bubbles, precisely seen FIG. 3b. Therefore, the present invention achieves the fully immersion of the resin glue into the prepreg 30 for greatly improving the wetness of the glue and the prepreg and reducing the generation of the bubbles.

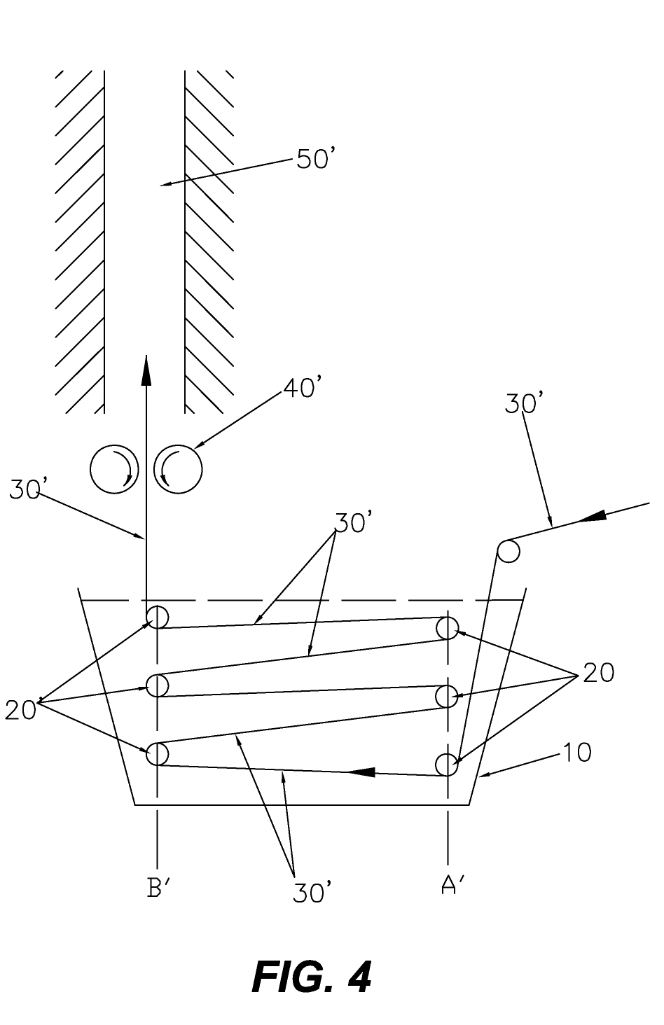

Referring to FIG. 4, another preferred embodiment of the present invention still comprises the elements similar to the previous embodiment. Differently, six revolving shafts 20 are totally disposed inside the basin 10, and two imagine lines A, B, perpendicular to the bottom of the basin 10, are respectively formed by the alignments of the partial shafts 20 and the remaining shafts 20. Therefore, the prepreg 30 driven by those shafts 20 is laterally transported from the bottom side of the basin 10 to the top side thereof; further, the prepreg 30 thence passes through the pressing shaft 40 and enters into the glue stove 50, thereby extending the soaking time of the prepreg 30 and reducing the bubbles existed in the prepreg 30. Further, the device of the present invention can optionally have four to eight revolving shafts.

To sum up, the present invention takes advantages of the prepreg transversely transported from the bottom side of the basin to the top side thereof, which facilitates to extend the time for soaking the prepreg and fully immerse the resin glue in the prepreg so as to reduce bubbles existed in the prepreg. Consequently, the present invention is able to increase the composite quality of the copper-clad laminate and the reliability of the metal resistant ion without adding more equipment.

While we have shown and described the embodiment in accordance with the present invention, it should be clear to those skilled in the art that further embodiments may be made without departing from the scope of the present invention.

I claim:

1. A device with revolving shafts for transversely soaking prepreg comprising a basin filled with resin glue, characterized in that a plurality of revolving shafts being disposed inside said basin for allowing said prepreg winding thereon, whereby said prepreg being able to laterally transported from a bottom side of said basin to a top side of said basin via the driving of said shafts.

2. The device as claimed in claim 1, wherein, said prepreg is fabricated of a fiber glass cloth, a fiber sheet or a fiber fabric.

3. The device as claimed in claim 2, wherein, three to eight revolving shafts are preferably disposed within said basin.

4. The device as claimed in claim 3, wherein, said revolving shafts are longitudinally connected to form two respective imagine lines, and said two imagine lines are in parallel.

5. The device as claimed in claim 4, wherein, said two imagine lines are perpendicular to the bottom of said basin.
